(19) United States
(12) Patent Application Publication
(10) Pub. No.: US 2011/0004587 A1
(43) Pub. Date: Jan. 6, 2011

(54) METHOD AND APPARATUS FOR AUTOMATICALLY SEARCHING FOR DOCUMENTS IN A DATA MEMORY

(75) Inventor: Marc-Peter Schambach, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/830,895

(22) Filed: Jul. 6, 2010

(30) Foreign Application Priority Data
Jul. 6, 2009 (DE) 10 2009 031 872.0

(51) Int. Cl. G06F 17/30

(52) U.S. Cl. 707/706; 707/E17.108

(57) ABSTRACT

A method and an apparatus search for documents in a data memory. A search query and a set of documents stored in the data memory are prescribed. For each document in the set of documents a respective computer-evaluatable description of the document is generated. The document is broken down into document portions. For each document portion at least one result of deciphering of the document portion is ascertained, wherein for at least one document portion a plurality of deciphering results are ascertained and stored. For each document in the set of documents a measure of the match between the document and the search query is calculated. For calculating the measure of match between a document and the search query, a degree of match is calculated for each stored possible deciphering result. The calculated degrees of match are taken as a basis for selecting at least one document in the set.

### CROSS-REFERENCE TO RELATED APPLICATION

This application claims the priority, under 35 U.S.C. §119, of German application DE 10 2009 031 872.0, filed Jul. 6, 2009; the prior application is herewith incorporated by reference in its entirety.

### BACKGROUND OF THE INVENTION

### Field of the Invention

The invention relates to a method and an apparatus for automatically searching for documents in a data memory.

The following is known from Internet search engines: a user inputs a search query into an input field of a search engine and stipulates whether a search is to be performed for text documents, pictures, video sequences or the like. The search engine presents the results sorted in decreasing order on a screen.

Conventionally, descriptors for a document are prescribed and stored in a data memory, e.g. a server for the Internet. By way of example, descriptors for a picture or “tags” for an “Internet site” are allocated. These descriptors form a computer-accessible description of the document. A search query compares a character string in the search query with these descriptors.

This method has the drawback that it requires correct descriptors. Although methods are known for producing descriptors semi-automatically, e.g. by applying a method for automatic character recognition to a computer-accessible document, the provision of correct descriptors requires the automatically produced descriptors to be checked and corrected manually. This may be associated with considerable complexity.

European patent EP 1312039 B1 describes a method and an apparatus for searching in an inventory of computer-accessible documents. By way of example, the computer-accessible documents are produced by virtue of paper-bound documents being scanned in and stored. “Optical character recognition (OCR)” is used to decipher words in the computer-accessible document. Furthermore, a respective error probability (“probabilistic degree of error”) is calculated for the deciphering. A search query with a keyword is prescribed. If the discrepancy between the keyword and a word in a document is lower than the error probability, the document for the word is output as a search result which matches the keyword.

Methods for searching in document inventories are also known from European patent EP 0764305 B1, published, non-prosecuted German patent application DE 10112587 A1 (corresponding to U.S. Pat. No. 5,706,365), U.S. patent publication Nos. 2002/0069190 A1, 2004/0024739 A1, 2002/0103798 A1, 2004/0068697 A1, international patent publication WO 2008/064378 A1 (corresponding to U.S. patent publication No. 020100061634), U.S. Pat. No. 7,356,461 B1, U.S. patent publication Nos. 2007/0300190 A1, 2007/0288442 A1,2006/0036566 A1, and U.S. Pat. Nos. 5,855,015, 6,366,908 B1, 6,006,221, 5,987,457 and 5,787,424.

### SUMMARY OF THE INVENTION

It is accordingly an object of the invention to provide a method and an apparatus for automatically searching for documents in a data memory which overcome the above-mentioned disadvantages of the prior art methods and devices of this general type, in which the documents are found even if it is not possible to produce an unequivocally correct description of the document, without having to produce descriptions manually or having to correct automatically produced descriptions manually.

The method according to the solution searches for a document in a data memory with computer-accessible documents.

A set of computer-accessible documents which is stored in the data memory is prescribed. This set may comprise all documents or an exactly defined subset of all documents.

For each document in the set of documents a respective computer-evaluatable description of the document is generated. The generation of this description includes the now described steps:

a) The document is broken down into document portions.

b) For each document portion at least one result of deciphering of the document portion is ascertained and is stored in the data memory. In this context, for at least one document portion a plurality of possible deciphering results for the document portion are ascertained and stored.

c) In this context, a method for automatic character recognition is applied in the steps of breakdown and deciphering.

d) These generation steps are performed automatically by a data processing installation.

This description is stored in the data memory, wherein an automatically evaluatable link is set up between the description and the document.

A computer-accessible search query is prescribed. The method according to the solution and the apparatus according to the solution provide documents which fit this search query.

For each document in the set of documents a measure of the match between the document and the prescribed search query is calculated. In order to calculate the measure of match between a document and the search query, the following steps are performed:

a) For each stored possible deciphering result for a document portion a degree of match is calculated; and

b) The measure of match between the document and the search query is calculated by combining the degrees of match. Each degree of match describes a degree for the match between the document portion deciphering result and the prescribed search query.

The measure of match and hence the calculated degrees of match are taken as a basis for selecting at least one document in the set. The set of selected documents is used as the result of the search query.

The method according to the solution and the apparatus according to the solution perform the generation of the description, the calculation of the measures of match and the selection of the documents automatically. It is possible, but not necessary, for a user subsequently to check or change the stored description manually. This allows even a comprehensive set of documents to be provided for an automatic search and thereby made accessible for a search. If one had to allocate head words (descriptors) manually for each of these documents or if one had to completely capture each document in another way, it would take a very long time and require a high level of complexity in order to make the documents accessible to a search.

According to the solution, a plurality of possible deciphering results for a document portion are stored and used for the search. The invention dispenses with the need to make a decision for one of these possible deciphering results. This decision can often only be made either with uncertainty or with a manual input, which is often undesirable or too complex.

The invention can be applied for search queries in the following archives with documents, for example: data memory with patient records, land register extracts, newspaper and periodicals archives, recordings from a camera which is set up at a public place, e.g. a road junction or a station, patient registers, data memory with documentaries or feature films, data memory with recordings of television programs, data memory with pieces of music containing sung texts, and data memory with recordings of speeches and other spoken texts.

In the exemplary embodiment, an archive is available with a large number of documents. These documents may have at least one of the following formats: paper-bound documents, e.g. records, newspapers; audio documents (audiotapes, phonograph records, . . . ); picture documents (paper pictures) or film and/or video documents, e.g. analog films.

These documents are digitized and thereby made computer-accessible. The digitization results are stored in a data memory, preferably a relational database. The database may be part of a server. The server may be accessible via an intranet or the Internet from workstation computers (“clients”).

Preferably, for each document a data record is created in a data memory in the form of a database. The data record contains a reference to a computer-accessible representation of the document.

In the case of a paper-bound document, a process of scanning produces a digital depiction of the document. An audio document, picture document, film document or video document is converted into a respective suitable data format which allows the storage and reproduction of sounds and/or pictures and/or picture sequences on a data processing installation.

All of these computer-accessible documents contain depictions of texts. The depictions of paper-bound documents usually exhibit primarily text. Audio documents often contain sequences of spoken language, e.g. speeches or sung texts. In pictures or films, texts are shown, e.g. overlays, subtitles, labels for objects shown, license numbers of road vehicles or identifiers for containers or vehicles. In the exemplary embodiment, the aim is to search for documents which contain a particular character string, e.g. in the form of printed text or in the form of spoken or sung words.

Other features which are considered as characteristic for the invention are set forth in the appended claims.

Although the invention is described herein as embodied in a method and an apparatus for automatically searching for documents in a data memory, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DETAILED DESCRIPTION OF THE INVENTION

The exemplary embodiment first of all involves a generation step being performed. A generation computer produces a respective computer-accessible description for each document in the data memory. It is possible to produce a respective description only for a previously selected set of documents or else to produce a respective description first of all only for some documents and then for the remaining documents. In the exemplary embodiment, the generation computer operates fully automatically and has read and write access to the data memory with the computer-accessible documents from the archive.

A text document is analyzed by the generation computer using character recognition (“optical character recognition”, OCR). In this case, the whole document or else a previously selected range is broken down into document portions. A document portion may for its part comprise document portions. Examples of document portions are columns, lines, words and letters.

A picture document or film document is examined for depictions of text blocks using image processing (“pattern recognition”). Each text block depiction acts as a document portion and may for its part contain document portions.

An audio document is analyzed in corresponding fashion using voice processing (“speech recognition”). Document portions are individual words, for example.

The mere breakdown of a document into document portions may involve uncertainty. Therefore, the analysis method provides alternatives, that is to say a plurality of possible breakdowns into different document portions. In the exemplary embodiment, each of these alternatives is provided with a respective measure of breakdown certainty.

The document portions are deciphered. In the case of a voice document, “deciphering” means the recognition of spoken language by OCR. The method used for character recognition or picture evaluation or voice processing is often unable to decipher a document portion explicitly, but rather provides a plurality of alternative possible deciphering results. The deciphering of a document portion therefore involves uncertainty, which means that the method provides a plurality of possible deciphering results. These deciphering results in turn involve uncertainty. For each document portion a measure of deciphering certainty is calculated. This measure of deciphering certainty is a measure of how certainly the possible deciphering result matches the document portion.

Although it is possible to resolve the ambiguities for breakdown and deciphering by virtue of a plurality of candidates being presented to a user for selection and the user selecting the correct alternative and making an appropriate input into a data capture appliance, such a method being known in the field of postautomation as “video encoding” and being used to decipher address details on postal items, this would be far too time-consuming and expensive in the exemplary embodiment and is therefore not performed.

On the contrary, for each document portion every possible deciphering result is stored with the respective measure of deciphering certainty. The generation computer has write access to the data memory and assigns each document in the data memory the breakdown, the measures of breakdown certainty, the possible deciphering results and the measures of deciphering certainty.

Preferably, a registration database contains a respective data record for each computer-accessible document in the data memory. The data record contains a reference to the document and preferably a description of the breakdown into document portions, the measures of breakdown certainty, the possible deciphering results and the measures of deciphering certainty.

The results which are generated when the document portions of a document are deciphered are preferably represented as a graph or a set of graphs. By way of example, each line of a document is represented by a graph. Each node of such a graph represents an alternative for deciphering a document portion. Each edge represents a possible alternative breakdown of the document.

The successor nodes to a node which represents a possible deciphering result for a document portion are the suitable alternatives for deciphering the document portion which comes next in the document. Each path through such a graph is a possible deciphering result for the represented component of the document, e.g. for a line of a text document. The measures of deciphering certainty for the possible deciphering results are additionally stored in this graph.

These graphs are generated fully automatically and stored as a description of the document. This “indistinct description” requires approximately 10 to 100 times more memory space than conventional deciphering results without indistinctness. This requires no manual checking and correction. This is advantageous particularly because data memories always have relatively large storage capacities, whereas manual correction remains expensive.

At least once, a textual search query is prescribed. An automatic search is performed for those documents in the data memory which fit a prescribed search query. In the exemplary embodiment, a respective workstation computer “client” captures the search query and forwards it to the server with the data memory. The server evaluates the search query and transmits the response to the querying workstation computer. This workstation computer presents the result on a visual display unit.

In one refinement, the search query contains a character string. A user types the character string into a capture appliance on the workstation computer or inputs it using voice input. The character string may contain wildcards, more generally: a regular expression. It is also possible to prescribe a computer-accessible depiction of a text, e.g. a scanned-in signature or a detail from a document which shows a character string. This text depiction is also deciphered by character recognition, and the deciphering result is represented as a graph. The graph then acts as a search query.

In order to evaluate the search query, the search query is compared with that graph or those graphs of each document in that set of documents in which a search is to be performed. It is possible for the set of documents to contain all documents which are stored in the data memory. It is also possible to restrict the search to a subset of the stored documents in advance, e.g. all documents from a particular period or in relation to a particular subject area, the selection being an “acute selection” without alternatives.

The comparison of the search query with a portion which is represented as a node or a path element of the graph delivers a degree of match. The calculation of a degree of match involves the use of the definition of a distance and also the measures of breakdown certainty and measures of deciphering certainty. This degree of match is a measure of the match between a possible deciphering result for the document portion and the prescribed search query. As already set out, it is possible to store a plurality of alternative possible deciphering results. In this case, a plurality of different degrees of match are also calculated, namely one degree of match per possible deciphering result for the document portion. The different degrees of match for the possible deciphering results for a document portion are combined, in one embodiment, to form a single degree of match between the document portion and the search query.

The individual degrees of match are combined to form at least one measure of match between the search query and the document. This is done by applying an aggregation rule. By way of example, the measure of match used is the maximum degree of match between a document portion and the search query.

Information about the highest rated documents is output on the visual display unit of the querying workstation computer. By way of example, of the N highest rated documents, a respective detail from that depiction which has also been used for the automatic character recognition is displayed, N being a prescribed number. Alternatively, those documents whose measure of match with the search query exceeds a prescribed limit are output. This detail may already indicate the place in the depiction at which the text sequence which fits the search query appears. Hence, the user is shown documents which fit his search query.

Preferably, the automatically found documents are output in decreasing order according to the measure of match.

In one refinement, a “context” is additionally used. For example, a context may be:

a computer-accessible representation of a grammar for a natural language, e.g. in the form of derivation rules or a finite machine,
a computer-accessible dictionary for a natural language,
a computer-accessible dictionary for a specialist area, and
a computer-accessible description of a schema for the structure of documents in the data memory.

The schema indicates where which information is located in the document, e.g. on an extract from the land register. The schema (“template”) may also describe a form.

It is possible for a context to be prescribed as soon as the descriptions of the documents are generated as described above. The context excludes a few alternatives for the deciphering of document portions because these possible alternatives do not occur in the context. Alternatively, the context results in altered measures of security.

The prescribing of a context results in a context-dependent description of the document being generated. This context-dependent description preferably likewise has the form of a graph which has the structure as described above. Preferably, the original, that is to say context-independent, description of the document is retained, that is to say the original description and the context-dependent description are both stored in the data memory. It is possible for a plurality of contexts to be prescribed and for a respective context-dependent description to be generated and stored for each context.

In another refinement, a context is prescribed in addition to the search query. In response to the search query, context-dependent graphs are generated for the documents. However, this refinement prompts the response to the search query to be generated only after a relatively long time.

1. A method for searching for a document in a data memory having computer-accessible documents, wherein a search query and a set of documents stored in the data memory are prescribed, which comprises the steps of:
generating, for each document in the set of documents, a respective computer-evaluatable description of the document, performing the generating step with the additional steps of:
breaking down the document into document portions, the breaking down step involves an application of a method for automatic character recognition;
ascertaining for each document portion at least one result of deciphering of the document portion, the ascertaining involves an application of the method for automatic character recognition;
storing the result of deciphering of the document portion in the data memory;
calculating for the at least one result of deciphering of each document portion a respective measure of certainty, the respective measure of certainty is a measure of how certainly a result of deciphering matches the document portion;
storing the respective computer-evaluatable description of the document in the data memory;
calculating for each document in the set of documents a respective measure of the match between the document and the search query prescribed, the calculating step further containing the steps of:
calculating for each stored possible deciphering result a degree of match between the deciphering result and the search query;
using measures of certainty of a match for calculating the degrees of match; and
calculating the measure of match for the document by combining the degrees of match;
taking calculated degrees of match as a basis for selecting at least one document in the set of documents;
ascertaining and storing for at least one document portion a plurality of possible results for the deciphering of the document portion; and
calculating for each possible deciphering result of each document portion the respective measure of certainty.

2. The method according to claim 1, which further comprises:
prescribing a computer-accessible description of a context from which at least one document in the set of documents in the data memory originates; and
generating and storing for each document in the set of documents, a context-dependent description of the document; and
ascertaining and storing for each document portion, at least one respective possible context-dependent deciphering result which is compatible with the context.

3. The method according to claim 2, wherein the data memory stores both the description and the at least one context-dependent description of the document.

4. The method according to claim 2, wherein the computer-accessible description of context contains at least one of the following objects:
a computer-accessible representation of a grammar for a natural language;
a computer-accessible dictionary for a natural language;
a computer-accessible dictionary for a specialist area; and
a computer-accessible description of a schema for a structure of the documents in the data memory.

5. The method according to claim 2, which further comprises prescribing a context for the search query, and if the context has a computer-accessible context description and each document in the set of documents has a context-dependent description for the context stored in the data memory then the context-dependent descriptions of the documents are used as document descriptions.

6. The method according to claim 1, which further comprises:
producing for each automatically selected document a detail from the document;
displaying details produced from the selected documents on a visual display unit for selection;
detecting which of the displayed details has been selected; and
displaying the document from which the selected detail originates on the visual display unit.

7. The method according to claim 1, which further comprises:
displaying at least once for at least one document portion of the document in the set of documents, stored possible recognition results on a visual display unit for selection;
detecting which of the displayed recognition results have been selected; and
performing one of:
removing unselected possible recognition results from the description of the document; and
inserting the selected possible recognition results with an increased degree of match into the description of the document.

8. A search apparatus for searching for a document in a data memory, the data memory storing a set of computer-accessible documents, the search apparatus comprising:
an interface device;
a description generation device;
a search query capture device; and
a document selection device;
said interface device configured to set up read accesses and write accesses to the data memory for the search apparatus;
said description generation device configured to automatically generate, for each document in the set of documents, a respective computer-evaluatable description of the document and to initiate storage of said description in the data memory;
said search query capture device configured to capture a search query;
said document selection device configured to automatically:
calculate, for each document in the set of documents, a respective measure of a match between the document and a captured search query; and
take calculated degrees of match as a basis for selecting at least one document in the set;
said description generation device configured to perform the following steps during the generation of the description of the document:
breakdown the document into document portions; and
ascertain, for each document portion, at least one result of deciphering of the document portion, and storing it in the data memory;
said description generation device configured to:
apply a method for automatic character recognition in the steps of breakdown and deciphering;
calculate a respective measure of certainty for the respective at least one deciphering result of each document portion, the measure of certainty is a measure of how certainly the possible deciphering result matches the document portion;
said description generation device configured to:
ascertain and store, for a document portion, a plurality of possible results for the deciphering of the document portion; and
calculate and store a respective measure of certainty for each possible deciphering result of each document portion;
said document selection device configured to perform the following steps during calculation of the measure of match between a document and the captured search query:
calculate a degree of match for each stored possible deciphering result; and
calculate the measure of match for the document by combining the degrees of match.

9. The search apparatus according to claim 8,
further comprising a context data memory, said context data memory storing a computer-accessible description of a context from which at least one document in the data memory originates;
wherein said description generation device is configured to additionally generate, for each document in the set of documents, a context-dependent description of the document and to initiate storage of said description in the data memory; and
wherein said description generation device ascertains, for each document portion, at least one respective possible context-dependent deciphering result which is compatible with the context, and initiates storage of said deciphering result.

10. A method for searching for a document in a data memory having computer-accessible documents, wherein a search query and a set of documents stored in the data memory are prescribed, which comprises the steps of:
generating, for each document in the set of documents, a respective computer-evaluatable description of the document;
storing the respective computer-evaluatable description of the document in the data memory;
calculating for each document in the set of documents a respective measure of a match between the document and the search query prescribed;
taking calculated degrees of match as a basis for selecting at least one document in the set of documents;
for each document in the data memory the generation of the description comprises the following steps:
breaking down the document into document portions;
ascertaining for each document portion at least one result of deciphering of the document portion;
storing the result of deciphering of the document portion in the data memory;
the ascertaining and breaking down steps involve an application of a method for automatic character recognition; and
calculating for the at least one result of deciphering of each document portion a respective measure of certainty, the respective measure of certainty is a measure of how certainly a result of deciphering matches the document portion;
ascertaining and storing for at least one document portion a plurality of possible results for the deciphering of the document portion;
calculating for each possible deciphering result of each document portion the respective measure of certainty;
the calculation of the measure of match between the document and the search query contains the further steps of:
calculating for each stored possible deciphering result a degree of match between the deciphering result and the search query;
using measures of certainty of a match for calculating the degrees of match; and
calculating the measure of match for the document by combining the degrees of match.
